(19) United States
(12) Patent Application Publication
(10) Pub. No.: US 2017/0297043 A1
(43) Pub. Date: Oct. 19, 2017

(54) SPRAY NOZZLE WITH FLOATING TURBINE

(71) Applicant: Harold D. Curtis Revocable Trust, Oklahoma City, OK (US)

(72) Inventor: Harold D. Curtis, Oklahoma City, OK (US)

(21) Appl. No.: 15/491,757

(22) Filed: Apr. 19, 2017

Related U.S. Application Data
(60) Provisional application No. 62/324,544, filed on Apr. 19, 2016.

(51) Int. Cl. B05B 3/04

(52) U.S. Cl. CPC B05B 3/0427; B05B 3/0431

(57) ABSTRACT

A spray nozzle that includes a nozzle body defining a first surface, a cap defining a second surface able to define an annular nozzle opening therebetween, a turbine having a plurality of radially extending fins circumferentially positioned about the nozzle opening for directing the flow of fluid exiting the nozzle opening, and a reverser member including a cup portion positioned below the cap to intercept the flow of fluid from a flow passage of the cap. The reverser member coupled to the turbine such that the reverser member is caused to rotate in response to rotation of the turbine.

### CROSS-REFERENCE TO RELATED APPLICATION

This application claims priority to U.S. Provisional Application Ser. No. 62/324,544, filed on Apr. 19, 2016, the entire contents of which being hereby expressly incorporated herein by reference.

### BACKGROUND

Cooling towers typically utilize a grid work of overhead nozzles to form a plurality of overlapping spray patterns for the purpose of distributing water over the upper surface of a layer of fill material through which air is drawn. The water flows downward through the fill material as the air flows upward through or across the fill material whereby the heat of the water is transferred to the air.

It is important to obtain as uniform a distribution as possible of the water over the upper surface of the fill material so that the water will uniformly flow through the fill material across the entire cross-sectional area of the tower. If the water distribution is not uniform, channels of uneven water loading will develop which cause the formation of low pressure paths through which the air will channel, thus greatly reducing the efficiency of the heat exchange operation conducted by the cooling tower.

It has been found that the efficiency of the heat exchange operation is greatly increased by using fluid distributing devices or nozzles that will create a plurality of abutting or overlapping square spray patterns, such as that disclosed in U.S. Pat. No. 5,152,458, the entire contents of which are hereby incorporated herein by reference. The formation of square spray patterns enables the spray patterns to be mated with each other so that voids or gaps do not exist between adjacent spray patterns. However, inefficiencies may still occur if the fluid distributed by each nozzle is not distributed uniformly across each of the individual square spray patterns.

The nozzles typically include a nozzle body, a cap, and a turbine. The nozzle body is provided with a central hub fixed within a fluid passage of the nozzle body with a plurality of radially spaced ribs. The cap has a stem with a central bore. The stem is configured to be slidingly registered in the central hub of the nozzle body. The cap is connected to the nozzle body so that the nozzle body and the cap are spaced apart from one another to define an annular nozzle opening therebetween.

The turbine has a mounting ring sized to be positioned about the nozzle body and a plurality of fins extending circumferentially about a bottom surface of the nozzle body. The fins extend radially outward from the bottom surface of the mounting ring so that the fins are positioned to intercept the fluid exiting the nozzle opening and uniformly distribute the water. The mounting ring is held in place by a locking ring so that the turbine is freely rotatable relative to the nozzle body and the cap. The mounting ring of the turbine is generally flat so that a portion of the fluid exiting the nozzle opening flows across the bottom of the mounting ring. The flow of fluid across the mounting ring in this manner creates a fluid bearing on which the turbine rotates.

While such nozzles have met with success, drawbacks nevertheless are encountered. In particular, such cooling tower nozzles are subject to failure as a result of the mounting ring contacting the locking ring. The contact creates a wear point.

To this end, a need exists for a spray nozzle which overcomes the problems of the prior art. It is to such a spray nozzle that the inventive concepts disclosed herein are directed.

### DESCRIPTION OF THE SEVERAL VIEWS OF THE DRAWINGS

FIG. 1 is an exploded, perspective view of a spray nozzle constructed in accordance with the inventive concepts disclosed herein.

FIG. 2 is a sectional view of the spray nozzle of FIG. 1 shown with a pair of fasteners removed.

FIG. 3 is a bottom perspective view of a nozzle body and a retaining member of the spray nozzle.

FIG. 4 is a top perspective view of the nozzle body and the retaining member of FIG. 3.

FIG. 5 is a bottom perspective view of another embodiment of a nozzle body.

FIG. 6 is a bottom perspective view of another embodiment of a nozzle body.

FIG. 7 is a bottom perspective view of another embodiment of a nozzle body.

FIG. 8 is a bottom plan view of a reverser member of FIG. 1 shown connected to another embodiment of a turbine.

### DETAILED DESCRIPTION OF EXEMPLARY EMBODIMENTS

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted.

The systems and methods as described in the present disclosure are capable of other embodiments or of being practiced or carried out in various ways. Also, it is to be understood that the phraseology and terminology employed herein are for purposes of description, and should not be regarded as limiting.

The following detailed description refers to the accompanying drawings. The same reference numbers in different drawings may identify the same or similar elements.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements, but may also include other elements not expressly listed or inherent to such process, method, article, or apparatus.

Further, unless expressly stated to the contrary, “or” refers to an inclusive and not to an exclusive “or.” For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, any reference to “one embodiment,” “an embodiment,” “some embodiments,” “one example,” “for example,” or “an example” means that a particular element, feature, structure or characteristic described in connection with the embodiment is included in at least one embodiment. The appearance of the phrase “in some embodiments” or “one example” in various places in the specification is not necessarily all referring to the same embodiment, for example.

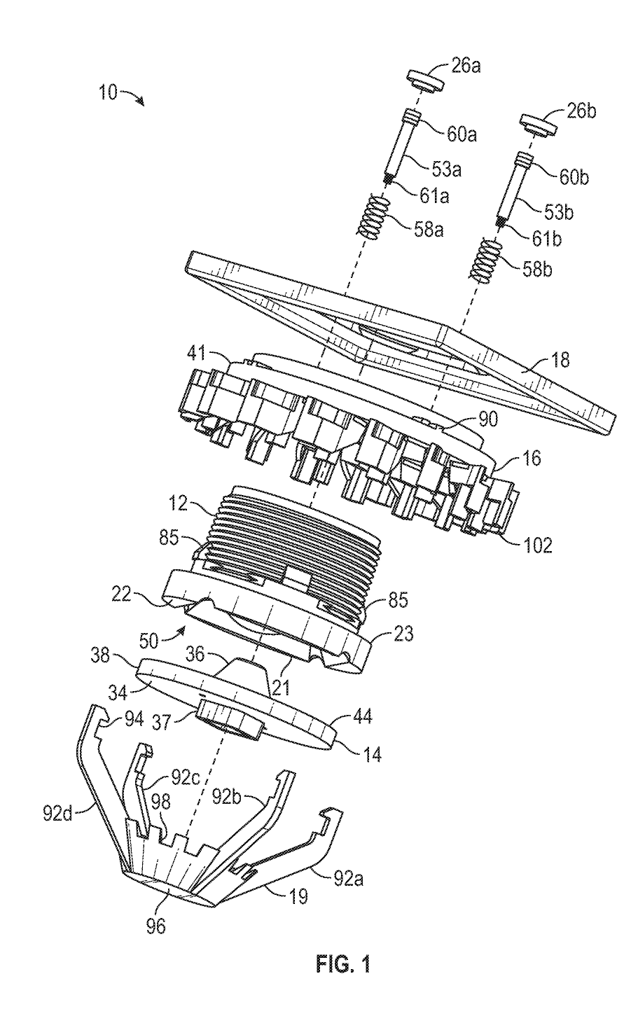

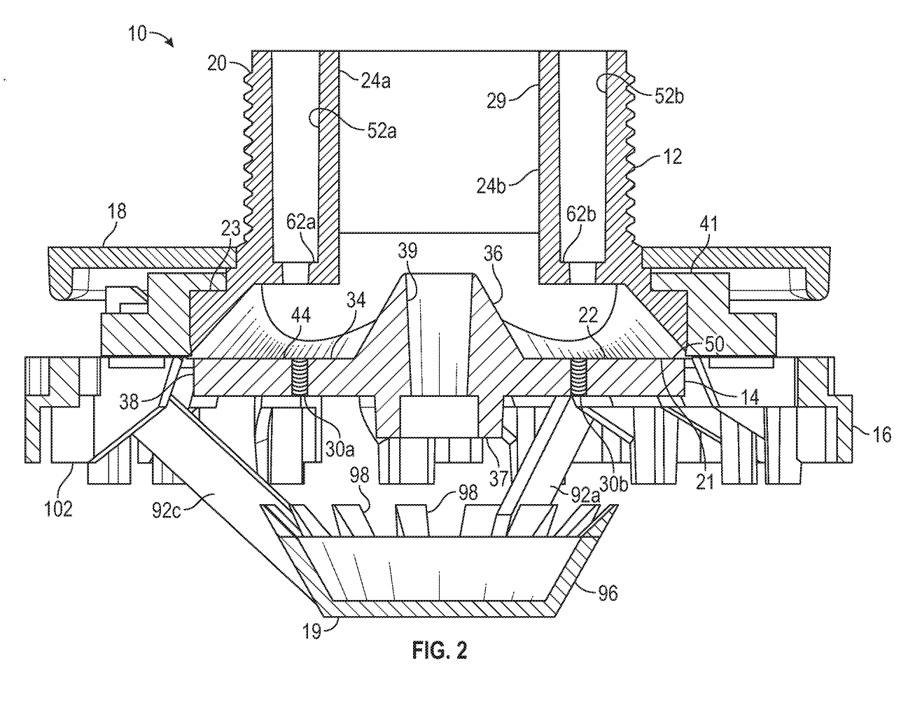

Referring now to FIGS. 1-2, shown therein is one embodiment of a spray nozzle 10 constructed in accordance with the inventive concepts disclosed herein. The spray nozzle 10 includes a nozzle body 12, a cap 14, a turbine 16, a retaining member 18, and a reverser member 19.

The nozzle body 12 is a generally tubular member defining a fluid passage 29 (FIG. 2). The nozzle body 12 has a threaded inlet end 20 for connecting the nozzle body 12 to a fluid distributing header (not shown) and an outlet end 21 provided with a flange 23 having an irregular shaped annular surface 22.

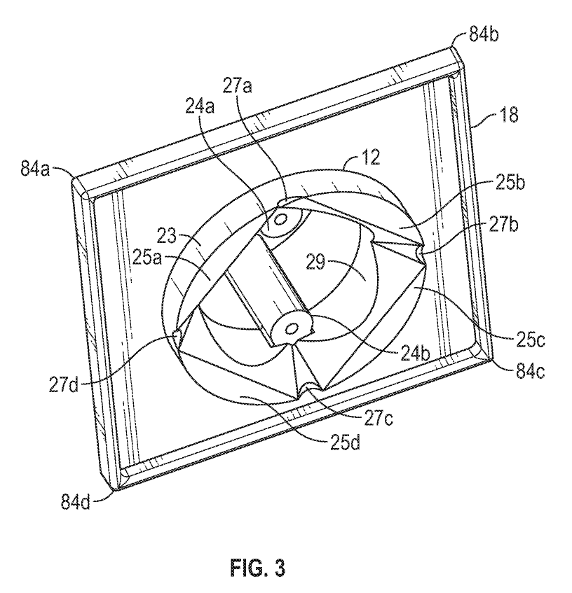

The irregular shaped annular surface 22 is an undulating surface having four peaks 25a-25d (FIG. 3) equally spaced at 90 degree intervals about the circumference of the annular surface 22 and four troughs 27a-27d (FIG. 3) located between the peaks 25a-25d and also being substantially equally spaced. One of the troughs 27a-27d is located equidistant between each adjacent pair of peaks 25a-25d.

The nozzle body 12 is further provided with peg portions 24a and 24b. The peg portions 24a and 24b are diametrically formed on the circumference of the fluid passage 29 of the nozzle body 12. While two peg portions are illustrated, it will be appreciated that any number of peg portions may be employed. The peg portions 24a and 24b are provided with a longitudinal bore 52a and 52b extending through the peg portions 24a and 24b. The bores 52a and 52b include shoulders 62a and 62b at a distal end thereof. Compression springs 58a and 58b (FIG. 1) are positioned in the longitudinal bore 52a and 52b and secured therein with fasteners 53a and 53b. The fasteners 53a and 53b are slidably disposed through the compression springs 58a and 58b, extend from the distal end of the longitudinal bore 52a and 52b, and are connected to the cap 14 via threaded openings 30a and 30b. The fasteners 53a and 53b may be shoulder bolts formed of an appropriate material, such as stainless steel, to resist corrosion. The fasteners 53a and 53b have heads 60a and 60b which cooperate with the shoulders 62a and 62b to retain the compression springs 58a and 58b. The longitudinal bores 52a and 52b may be filled with a lubricant (not shown) and sealed with caps 26a and 26b.

FIG. 5 illustrates another embodiment of a nozzle body 12a. The nozzle body 12a is similar to the nozzle body 12 except the nozzle body 12a has troughs 33a and 33b and troughs 35a and 35b. Each of the troughs 33a, 33b, 35a, and 35b has a rectangular shape rather than a semi-oval shape as shown for the troughs 27a-27d. In addition, the troughs 33a and 33b, which are positioned adjacent to the peg portions 24a and 24b, respectively, are formed to have a flow area greater than the flow area of the troughs 35a and 35b. In one embodiment, the flow area of the troughs 33a and 33b is increased relative to the flow area of the troughs 35a and 35b by forming the troughs 33a and 33b to have a width greater than the width of the troughs 35a and 35b.

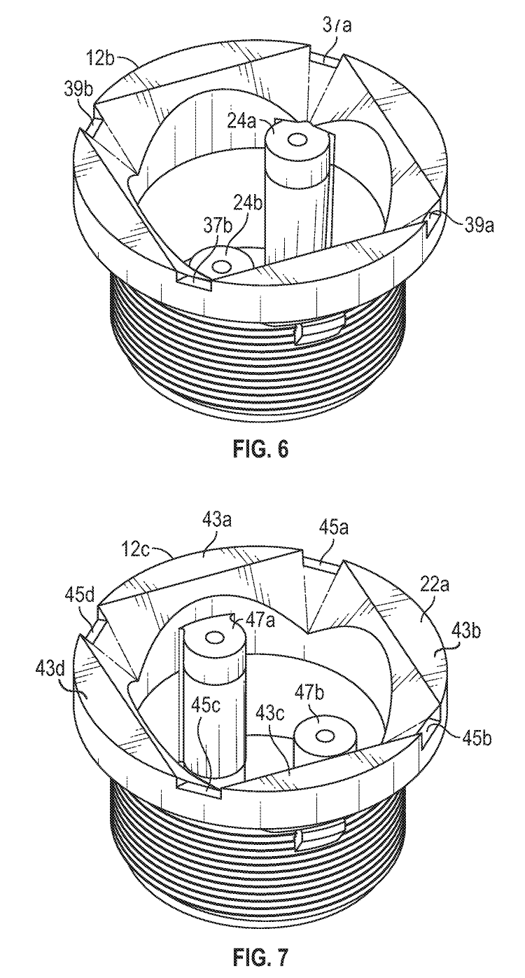

FIG. 6 illustrates another embodiment of a nozzle body 12b. The nozzle body 12b is similar to the nozzle body 12a except the nozzle body 12b has troughs 37a and 37b and troughs 39a and 39b. Each of the troughs 37a, 37b, 39a, and 39b has a rectangular shape rather than a semi-oval shape as shown for the troughs 27a-27d. In addition, the troughs 37a and 37b, which are positioned adjacent to the peg portions 24a and 24b, respectively, are formed to have a flow area less than the flow area of the troughs 39a and 39b. In one embodiment, the flow area of the troughs 37a and 37b is decreased relative to the flow area of the troughs 39a and 39b by forming the troughs 37a and 37b to have a width less than the width of the troughs 39a and 39b.

FIG. 7 illustrates yet another embodiment of a nozzle body 12c. The nozzle body 12c is similar to the nozzle body 12 except the nozzle body 12c has an irregular shaped annular surface 22a that is an undulating surface having four peaks 43a-43d equally spaced at 90 degree intervals about the circumference of annular surface 22a and four troughs 45a-45d located between the peaks 43a-43d and also being substantially equally spaced. One of the troughs 45a-45d is located equidistant between each adjacent pair of peaks 43a-43d. Each of the troughs 45a-45d is shown to have a rectangular shape rather than a semi-oval shape as shown for the troughs 27a-27d.

The nozzle body 12c is provided with peg portions 47a and 47b, which are similar to the peg portions 24a and 24b described herein, except the peg portions 47a and 47b are positioned adjacent the peaks 43a and 43c rather than being positioned adjacent the troughs. In addition, the peaks 43a and 43c, which are positioned adjacent the peg portions 47a and 47b, respectively, are formed to have a surface area less than the surface area of the peaks 43b and 43d.

Returning to FIGS. 1-2, the cap 14 has a disk portion 34, a conical portion 36, and a square portion 37. A fluid flow passage 39 passes through the disk portion 34 via the conical portion 36 and the square portion 37. The conical portion 36 extends from the disk portion 34 a distance sufficient to prevent debris from clogging the fluid flow passage 39.

The disk portion 34 of the cap 14 has a rim 38 that defines an annular surface 44 which has a substantially planar configuration. The peg portions 24a and 24b are aligned with threaded openings 30a and 30b in the cap 14 such that the fasteners 53a and 53b may threadingly connect the nozzle body 12 to the cap 14. In one version, the threaded openings 30a and 30b are defined by a metal fixture embedded in the disk portion 34 of the cap 14. The cap 14 is connected to the nozzle body 12 so that the annular surface 22 of the nozzle body 12 and the annular surface 44 of the cap 14 define a nozzle opening 50 therebetween. More specifically, the cap 14 is connected to the nozzle body 12 so that a portion of the annular surface 22 of the nozzle body 12 and the annular surface 44 of the cap 14 are engaged when the spray nozzle 10 is in an un-pressurized condition. However, when pressurized, the annular surface 22 of the nozzle body 12 and the annular surface 44 of the cap 14 become spaced apart from another. The advantage of this feature will be described below.

Because of the irregular shape of the surface 22, the spacing between the surface 22 and the surface 44 varies around a circumference of the annular nozzle opening 50 to create a non-circular spray pattern of fluid exiting the nozzle opening 50. In particular, a generally square spray pattern will be provided due to the formation of four troughs 27a-27d and four peaks 25a-25d. The fluid flowing past the peaks 25a-25d will define the corners of the square pattern because the peaks 25a-25d cause a flow restriction which increases the pressure of the fluid and thus causes the fluid to flow farther than the fluid flowing past the troughs 27a-27d. While the troughs 25a-25d have been illustrated as being semi-oval in shape and the other troughs described herein have been illustrated as being rectangular in shape, the troughs may be formed to have a variety of other shapes, including square, triangular, and semi-circular, by way of example.

The biased connection of the cap 14 to the nozzle body 12 created in part by the compression springs 58a and 58b provides an automatic adjusting mechanism for increasing the spacing between the first and second annular surfaces 22 and 44 in response to an increase in fluid pressure in the annular nozzle opening 50. When fluid pressure supplied to the spray nozzle 10 is increased, the increased force acting on the cap 14 will compress the springs 58a and 58b to increase the spacing between annular surfaces 22 and 44. By causing the first and second annular surfaces 22 and 44 of the spray nozzle 10 to engage in a non-pressurized condition, the need to maintain tight tolerances with respect to the minimum spacing between the annular surfaces 22 and 44 is eliminated. Instead, the reaction of the cap 14 to fluid pressure is dependent on the tension of the compression springs 58a and 58b.

It will be appreciated that in the absence of the variable or automatic nozzle adjustment provided by the springs 58a and 58b and the sliding engagement of cap 14 with the nozzle body 12, a substantial increase in fluid supply pressure would cause the spray pattern to be extended radially outward to an undue extent and would tend to create a void in the center of the pattern. Conversely, a decrease in flow supply pressure would cause the spray pattern to be reduced radially inward and would tend to create a void in the outer perimeter of the spray pattern. By appropriate choice of the spring rate of the springs 58a and 58b, the spray nozzle 10 will automatically adjust the cross-sectional area of the annular nozzle opening 50 so as to maintain a substantially uniform spray pattern over a wide range of fluid supply pressures and flow rates.

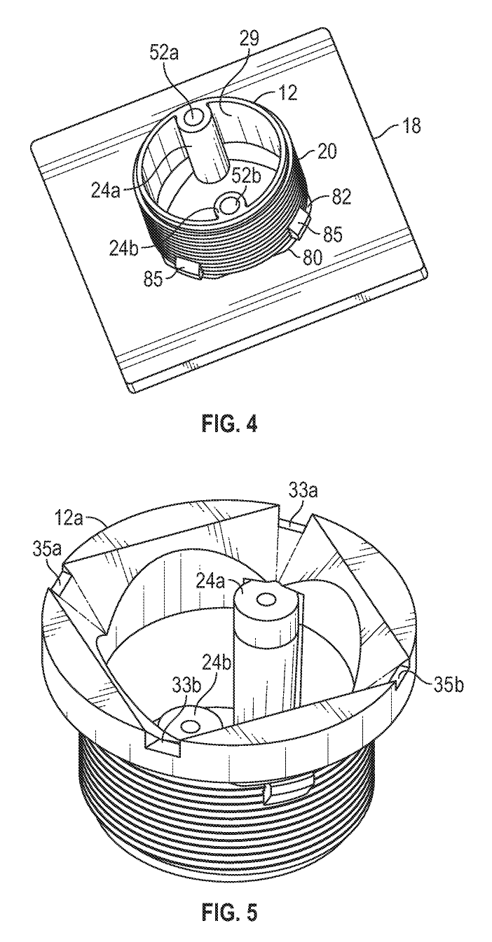

Referring now to FIGS. 3 and 4, shown therein is the retaining member 18 connected to the nozzle body 12. The retaining member 18 is provided with at least one keyway 80 which aligns with at least one key 82 on the nozzle body 12 to substantially align four corners 84a-84d of the retaining member 18 with the four peaks 25a-25d of the nozzle body 12. In such an embodiment, the retaining member 18 is a representation of a spray pattern of the spray nozzle 10 thus allowing the spray pattern to be visualized as the spray nozzle 10 is attached to the fluid distributing header thus allowing easier alignment of the spray nozzle 10. The nozzle body 12 is provided with a plurality of retaining tabs 85 that are configured to slidingly receive and retain the retaining member 18.

In one embodiment of the spray nozzle 10, the retaining member 18 is sized to extend over a substantial portion of the turbine 16 so as to prevent at least some drift droplets (sometimes referred to as drift emissions) from rising above the spray nozzle 10. Drift droplets that may have been caught in an airstream and carried out of the cooling tower will instead contact the underside of the retaining member 18 and eventually drop through the cooling tower as desired. In this way, unwanted emissions from the cooling tower may be reduced.

The connection between the retaining member 18 and the nozzle body 12 may facilitate the connection of the spray nozzle 10 to the fluid distributing header. For instance, in one embodiment, a service technician may grasp the retaining member 18 to rotate the spray nozzle 10 to threadingly connect the spray nozzle 10 to the fluid distributing header. In one embodiment of the spray nozzle 10, a connection tool (not shown) may be provided having two parallel sides and a gap in between. The connection tool may be used to fasten the spray nozzle 10 to the fluid distributing header. In such an embodiment, the gap of the connection tool is configured to receive the retaining member 18. Because of the connection between the retaining member 18 and the nozzle body 12, rotation of the retaining member 18 with the connection tool rotates the nozzle body 12 facilitating the threading connection of the nozzle body 12 to the fluid distributing header, for instance.

In one embodiment, the nozzle body 12, the cap 14, and the retaining member 18 may be constructed of a durable polymeric material, such as acetyl.

Referring again to FIGS. 1 and 2, the turbine 16 includes a mounting ring 41 sized to be positioned about the nozzle body 12, yet engageable with the flange 23 of the nozzle body 12 so that the turbine 16 is rotatable about the nozzle body 12 and a plurality of fins 102 extending circumferentially about a bottom surface of the mounting ring 41. More particularly, the turbine 16 may be constructed in accordance with the turbines disclosed in U.S. Pat. No. 7,261,248, which is hereby incorporated herein in its entirety by reference.

The reverser member 19 includes a cup portion 96 and a plurality of arms 92a-92d extending radially outward and upward from the cup portion 96. A rim of the cup portion 96 may be provided with notches 98 for diffusing fluid. The arms 92a-92d of the reverser member 19 are provided with clip portions 94 (only one of which is numbered in FIG. 1) configured to clip onto the turbine 16. The turbine 16 is provided with adapters 90 (only one of which is numbered in FIG. 1) configured to accept the clip portions of the arms 92a-92d of the reverser member 19. With the arms 92a-92d attached to the turbine 16, the cup portion 96 is positioned below the cap 14 in a spaced relationship thereto and substantially aligned with the fluid flow passage 39 of the cap 14 such that fluid passing through the fluid flow passage 39 of the cap 14 is directed into the cup portion 96 and the reverser member 19 is caused to rotate in response to rotation of the turbine 16.

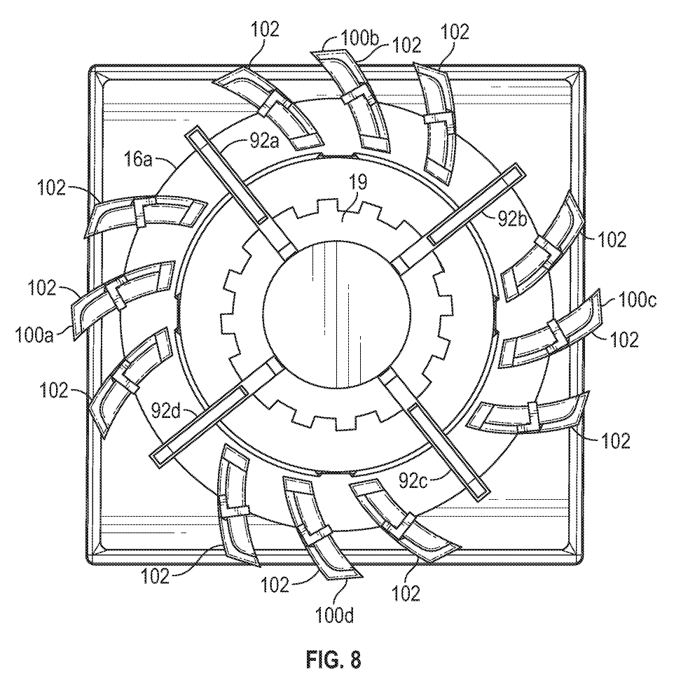

FIG. 8 shows another embodiment of a turbine 16a that is similar in construction to the turbine 16, except the turbine 16a is constructed to have a plurality of groups of fins 100a-100d. Each group of fins 100a-100d may contain any number and shape of fins 102 and the fins 102 may be equally spaced from one another. The groups of fins 100a-100d are spaced apart from one another a distance greater than the distance between adjacent fins 102 of each group of fins 100a-100d. In connecting the reverser member 19 to the turbine 16a, the arms 92a-92d may be positioned between the groups of fins 100a-100d in a way that the arms 92a-92d are non-radially aligned with the fins 102 of the turbine 16a, thereby not interfering with the distribution of water being deflected from the fins 102.

In operation, a portion of the fluid flowing through the spray nozzle 10 flows through the fluid flow passage 39 of the cap 14 and contacts the inside of the cup portion 96 causing a downward force on the turbine 16. The fluid flow passage 39 is sized such that the downward force applied to the cup portion 96, and thus the turbine 16, balances the upward force created by the fluid exiting the nozzle opening 50 to cause the turbine 16 to remain spaced from the cap 14 and the retaining member 18. In this way, a cushion of water forms between the turbine 16 and the retaining member 18 to reduce the rate of wear as the turbine 16 rotates.

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the scope and coverage of the inventive concepts disclosed and claimed herein.

What is claimed is:

1. A spray nozzle, comprising:
a nozzle body defining a first surface and a fluid passage;
a cap defining a second surface, the cap connected to the nozzle body such that the first surface of the nozzle body and the second surface of the cap form an annular nozzle opening therebetween, the cap biased toward the nozzle body to allow the spacing between the first surface and the second surface to increase in response to an increase in fluid pressure in the nozzle opening, the cap having a flow passage extending therethrough to permit fluid to pass through the cap and bypass the nozzle opening;
a turbine having a plurality of radially extending fins circumferentially positioned about the nozzle opening for directing the flow of fluid exiting the nozzle opening, the turbine being rotatable about the nozzle opening and the nozzle opening being free of any portion of the turbine; and
a reverser member including a cup portion positioned below the cap to intercept the flow of fluid from the flow passage of the cap, the reverser member coupled to the turbine such that the reverser member is caused to rotate in response to rotation of the turbine.

2. The spray nozzle of claim 1, wherein the turbine has a mounting ring from which the fins extend, wherein the spray nozzle further comprises a retaining member positioned about the nozzle body and over the mounting ring of the turbine, and wherein the flow passage of the cap is sized such that a portion of the fluid flowing through the spray nozzle flows through the flow passage of the cap and contacts the inside of the cup portion causing a downward force on the turbine such that the downward force applied to the cup portion balances the upward force created by the fluid exiting the nozzle opening to cause the turbine to remain spaced from the cap and the retaining member so that a cushion of water forms between the turbine and the retaining member as the turbine rotates.

3. The spray nozzle of claim 1, wherein a rim of the cup portion has notches for diffusing fluid.

4. The spray nozzle of claim 1, wherein reverser member has a plurality of arms extending radially from the cup portion, the arms coupled to the turbine.

5. The spray nozzle of claim 4, wherein the turbine has a plurality of groups of fins, each group of fins has a plurality of fins and the plurality of fins being equally spaced from one another, the groups of fins spaced apart from one another a distance greater than the distance between plurality of fins of each group of fins.

6. The spray nozzle of claim 5, wherein the arms of the reverser member are coupled to the turbine between the groups of fins in a way that the arms are non-radially aligned with the fins of the turbine.

7. The spray nozzle of claim 2, wherein the fluid flow passage of cap extends through a conical portion directing debris away from fluid flow passage.

8. The spray nozzle of claim 2, wherein the first surface is an undulating surface having four peaks substantially equally spaced about the circumference and four troughs located between the peaks so as to create a square spray pattern of fluid exiting the nozzle opening, and wherein the retaining member has four corners aligned with the four peaks of the nozzle body.

9. The spray nozzle of claim 2, wherein the first surface is an undulating surface having four peaks substantially equally spaced about the circumference and four troughs located between the peaks so as to create a square spray pattern of fluid exiting the nozzle opening, wherein the nozzle body has at least two tubular portions positioned in the fluid passage of the nozzle body, wherein the tubular portions are positioned adjacent two of the troughs, and wherein the troughs adjacent the tubular portions have a flow area different from a flow area of the other two troughs.

10. The spray nozzle of claim 9, wherein the flow area of each of the troughs positioned adjacent the tubular portions is greater than the flow area of each of the other two troughs.

11. The spray nozzle of claim 9, wherein the flow area of the two troughs positioned adjacent the tubular portions is less than the flow area of the other two troughs.

12. The spray nozzle of claim 2, wherein the nozzle body has at least two peg portions positioned in the fluid passage of the nozzle body, wherein each of the peg portions is positioned between two of the troughs adjacent one of the peaks, and wherein the peaks of the first surface positioned adjacent the peg portions have a surface area less than the surface area of the other two peaks.

13. A spray nozzle, comprising:
a nozzle body defining a first surface and a fluid passage;
a cap defining a second surface, the cap connected to the nozzle body such that the first surface of the nozzle body and the second surface of the cap form an annular nozzle opening therebetween, the cap biased toward the nozzle body to allow the spacing between the first surface and the second surface to increase in response to an increase in fluid pressure in the nozzle opening, the cap having a flow passage extending therethrough to permit fluid to pass through the cap and bypass the nozzle opening;
a turbine having a mounting ring and a plurality of fins circumferentially from the mounting ring, the fins positioned about the nozzle opening for directing the flow of fluid exiting the nozzle opening, the turbine being rotatable about the nozzle opening and the nozzle opening being free of any portion of the turbine; and
a retaining member positioned about the nozzle body and over the mounting ring of the turbine,
wherein the first surface is an undulating surface having four peaks substantially equally spaced about the circumference and four troughs located between the peaks so as to create a square spray pattern of fluid exiting the nozzle opening, and
wherein the retaining member has four corners aligned with the four peaks of the nozzle body.

14. A spray nozzle, comprising:
a nozzle body defining a first surface and a fluid passage;
a cap defining a second surface, the cap connected to the nozzle body such that the first surface of the nozzle body and the second surface of the cap form an annular nozzle opening therebetween, the cap biased toward the nozzle body to allow the spacing between the first surface and the second surface to increase in response to an increase in fluid pressure in the nozzle opening, the cap having a flow passage extending therethrough to permit fluid to pass through the cap and bypass the nozzle opening;
a turbine having a mounting ring and a plurality of fins circumferentially from the mounting ring, the fins positioned about the nozzle opening for directing the flow of fluid exiting the nozzle opening, the turbine being rotatable about the nozzle opening and the nozzle opening being free of any portion of the turbine; and
a retaining member positioned about the nozzle body and over the mounting ring of the turbine,
wherein the first surface is an undulating surface having four peaks substantially equally spaced about the circumference and four troughs located between the peaks so as to create a square spray pattern of fluid exiting the nozzle opening, and
wherein the nozzle body has at least two tubular portions positioned in the fluid passage of the nozzle body.

15. The spray nozzle of claim 14, wherein the tubular portions are positioned adjacent two of the troughs, and wherein the troughs adjacent the tubular portions have a flow area different from a flow area of the other two troughs.

16. The spray nozzle of claim 15, wherein the flow area of the two troughs positioned adjacent the tubular portions is greater than the flow area of the other two troughs.

17. The spray nozzle of claim 16, wherein each of the troughs has a rectangular shape.

18. The spray nozzle of claim 15, wherein the flow area of the two troughs positioned adjacent the tubular portions is less than the flow area of the other two troughs.

19. The spray nozzle of claim 18, wherein each of the troughs has a rectangular shape.

20. The spray nozzle of claim 14, wherein each of the peg portions is positioned between two of the troughs adjacent one of the peaks, and wherein the peaks of the first surface positioned adjacent the peg portions have a surface area less than the surface area of the other two peaks.

21. The spray nozzle of claim 20, wherein each of the troughs has a rectangular shape.
